(19) United States
(12) Patent Application Publication
(10) Pub. No.: US 2012/0131986 A1
(43) Pub. Date: May 31, 2012

(54) METHODS AND APPARATUS FOR TESTING AIR TREATMENT CHEMICAL DISPENSING

(76) Inventors: Padma Prabodh Varanasi, Racine, WI (US); Anne T. Maghasi, Racine, WI (US); Kwamena Gyakye deGraft-Johnson, Racine, WI (US); Yemi Susan Bullen, Kenosha, WI (US)

(21) Appl. No.: 12/052,152

(22) Filed: Mar. 20, 2008

Related U.S. Application Data
(60) Provisional application No. 60/896,299, filed on Mar. 22, 2007.

(51) Int. Cl. G01N 30/02

(52) U.S. Cl. 73/23.35

(57) ABSTRACT

Disclosed herein are methods for measuring the concentration of volatile air treatment chemicals in the air. These methods can be used to evaluate the effectiveness of, and/or optimize, dispensers that dispenses a volatile air treatment chemical into a test area. One runs side by side sampling of air using both sorbent tube and solid phase micro extraction fiber collectors to develop a correlation curve between air treatment chemical concentration results from the sorbent tube sampling and amount readings from the SPME sampling. One then uses SPME collectors to measure in a passive manner the performance of the volatile dispensers.

### CROSS-REFERENCE TO RELATED APPLICATIONS

This application claims priority based on U.S. provisional application 60/896,299, filed on Mar. 22, 2007.

### STATEMENT REGARDING FEDERALLY SPONSORED RESEARCH/DEVELOPMENT

Not applicable.

### BACKGROUND OF THE INVENTION

The present invention relates to methods for measuring air concentrations of air treatment chemicals. It particularly relates to techniques for doing so in ways which permit an evaluation of the potential effectiveness of dispensing products that deliver volatile air treatment chemicals.

Volatile materials are often dispensed into the air for various purposes. For example, volatile air treatment chemicals are useful in insect control, fragrancing, and disinfecting. These chemicals are typically dispensed from a variety of devices that use varied techniques to achieve dispensing. For example, a mosquito repellent can be dispensed by burning a mosquito coil, or by heating a pad or wick impregnated with the repellent, or by blowing air past an impregnated substrate.

When developing these dispensing products one seeks to optimize the concentration of active used, the carrier liquid for the active, the properties and placement of the substrate or other holder for the active, the electrical use requirements of the product, etc. Important in the development process is the ability to measure with reasonable accuracy whether, when, where and for how long a desired concentration of active is achieved around the dispenser under varied environmental conditions likely to be experienced by the consumer.

Testing strength of fragrancing products at particular spatial locations relative to a dispenser has in the past involved use of human subjects who record their impression as to the level of fragrance being delivered to the air simply by what they are able to perceive when they smell the air in a treated area. This requires human participation and relies heavily on elements of subjective response. This also may require a large number of test subjects to insure statistical significance to average out variability between test subjects. Moreover, the presence of the human in the test area will itself disturb the test environment.

When delivery products deliver insect control active ingredients into the air, so as to protect humans from biting insects such as mosquitoes or flies, human subjects are again typically used to test the efficacy of the products. The human subjects are placed in an environment populated by the insects, and after treatment of the area with the product the level of protection is recorded (e.g. how often are insect lands recorded or even how often are the test subjects bitten). This will require many test subjects to be exposed to insects. Further, accurately comparative insect response between multiple tests may be difficult as insects sometimes respond to different humans at different rates, depending on human odors, their heat, their carbon dioxide expiration rates, and other factors.

While certain characteristics of the volatile may also be measurable through the use of mechanical equipment, this often disturbs what is being measured. Further, the nature of what can be measured is sometimes limited.

For example, there is a technology called “sorbent tube” technology. Such tubes include a pumping system to extract an air sample, past the air sample into a collecting tube, and then permit the tube to be evaluated in a laboratory to measure concentration of an air treatment chemical at the sorbent tube location. However, this extraction disturbs the air being measured.

Conventional solid phase micro extraction (“SPME”) technology provides a fiber matrix that will trap air treatment chemicals in a passive manner as the air passes by. After being exposed to the chemicals, the fiber devices are subjected to chromatographic analysis to determine the components present in the materials trapped. U.S. patent application publication 2007/0154504 is an example of such a conventional use of SPME technology to collect volatile materials from the air for subsequent analysis of their components. However, it made no use of SPME technology to obtain air concentration information.

Other teachings of use of SPME technology to collect chemicals in air include U.S. Pat. Nos. 6,543,181 and 6,696,490.

U.S. patent application publications 2004/0136909 and 2006/0179708 show additional techniques for sampling air, albeit not involving SPME technology.

Notwithstanding these developments, there is a continuing need for improved techniques for measuring the concentration of volatile air treatment chemicals, particularly with respect to minimizing the need for human test subjects.

### BRIEF SUMMARY OF THE INVENTION

In one aspect the invention provides a method of measuring air concentration of a volatile material in an area. One correlates sorbent tube air concentration measurements of varied air concentrations of the volatile material to solid phase microextraction fiber collector responses to varied air concentrations of the volatile material. One then exposes a solid phase microextraction fiber collector to air in the area, and analyzes results of the exposing step using the results of the correlating step to estimate air concentration of the volatile material in the area from the results of the exposing step.

In preferred forms, one delivers the volatile material into the area from a volatile dispenser prior to the exposing step. The exposing step uses an array of solid phase microextraction fiber collectors located at selected distances and directions from the volatile dispenser. The volatile material is selected from the group consisting of insect control agents and fragrances and/or the volatile dispenser is selected from the group consisting of insect control agent dispensers and fragrance dispensers. Upon completion of the exposing step the solid phase microextraction fiber collector is automatically protected from further exposure to additional volatile material.

For example, the solid phase microextraction fiber collector can be automatically withdrawn into a protected holder by mechanical movement. The solid phase microextraction fiber collector can be automatically protected from further exposure via a remote control device. A solid phase micro extraction fiber collector that has collected the volatile material can then be subjected to chromatographic analysis, and/or prior to the above methods one can already be aware of a desired air concentration of the volatile material.

Using information from multiple operations in which SPME fibers are exposed to volatiles in air at the same time that the concentration of those volatiles is being determined via conventional sorbent tube techniques, a standard curve can be created that correlates particular SPME readings with air treatment chemical concentrations. When reading SPME measurements thereafter (without any sorbent tube measuring) one can interpret SPME readings as air concentration values, while having the benefit of a passive measurement system that does not disturb what is being measured during the measurement process.

This type of information is particularly desirable to have when optimizing the design of a dispenser product. If the reading at one dispenser setting/time is lower than desired, this may lead one to adjust or redesign the product so as to dispense a higher concentration. If the reading is higher than desired at a particular distance, this may lead one to adjust the product to dispense a lower concentration.

The solid phase micro extraction fiber collector that has collected the air treatment chemical is most preferably subjected to gas chromatography or mass spectrometry to determine said amount of air treatment chemical that has been collected.

As one example, the product can be an insect repellent. In such a case the known desired concentration may be that sufficient to achieve effective repelling of an insect in a typical exposure environment.

The test area may be in the form of an enclosed chamber, with the product being operated at a plurality of conditions. There can be essentially simultaneous collection of air treatment chemical by both a sorbent tube and a solid phase micro extraction fiber collector. This is followed by collection of air treatment chemical solely by the SPME device.

The effect of changes in temperature of the dispensing device or environment, changes in blowing force caused by the device or by ambient wind, different actives, different impregnation concentrations of active, different substrates, etc. and the like may be evaluated by further use of the present invention.

An array of the SPME devices can be positioned to surround the dispenser and/or provide three-dimensional measurements at different heights. Each SPME measurement position can be correlated with a sorbent tube concentration measurement adjacent that position, albeit one may be able to estimate a preliminary SPME correlation with particular types of sorbent tubes for a particular environment and active by making only one correlation graph at a particular location.

One can evaluate, through known techniques or already published information, the desired concentration of active to achieve insect repellency or another desired property. For a new active, this could be achieved using a limited set of human subject tests or direct exposure of insects to air-borne volatiles, with observation of insect knock-down, death, or other results.

Note that even though the effective concentration may be known for an old active such as DEET, further testing of each particular dispensing system that is being developed which uses it is still needed. Further, that testing will be needed even if the dispenser is also old if the old active is mixed in a different way.

Where the dispensing product is a fragrance, the known desired concentration will typically be a threshold concentration which humans report sufficient to result in their perceiving the fragrance at a satisfactory level. Hence, there as well, some human test subject involvement may initially be required to learn the desired effectiveness concentration. However, thereafter, no further human test subject involvement is needed when practicing the present invention.

Also, to reduce even that initial level of human test subject involvement, for some types of actives one may seek to use systems which measure effectiveness without a human test subject. While this would be difficult in the case of repellents or fragrances, it could easily be achieved for insecticides where the desired effect is killing. An enclosed test chamber could measure at what concentration a population of insects die, and how quickly, without any human test subject involvement. However, regardless of what is done to obtain knowledge about the desired effectiveness concentration, the correlation of air concentrations of actives as measured by sorbent tube measurements, with results achieved by the use of SPME fibers, followed by conventional chromatography, requires no human test subjects.

Test chambers for these correlation tests may have ports or other access mechanisms that allow for the simultaneous measurement of the air concentration of the active via conventional sorbent tube techniques and exposure of SPME fibers to the air. If ultimate test conditions are likely to vary in temperature or air movement, a further step is employed of exposing SPME fibers to a controlled concentration of volatilized active under successively increasing temperatures or successively increasing air flow rates, with the SPME fibers again analyzed by conventional chromatographic techniques.

Then, without use of sorbent tubes, one exposes SPME fibers to air into which a volatile dispensing product to be tested has delivered active, under essentially actual intended use conditions. Preferably, multiple SPME fibers are arranged in a spatial array around the volatile dispensing product to be tested so as to record air treatment chemical concentrations achieved at various distances and/or heights that are functionally important with respect to the intended use of the volatile dispensing product. Preferably the SPME fibers are containable in containment devices that can expose the fibers to the air for a selected period of time and then automatically contain them so as to prevent additional exposure.

Most preferably the containment devices can be controlled remotely, whether by wired connections or by conventional wireless methods. A containment device similar to a syringe is an example of such a containment device, where the SPME fiber can be thrust forth into the containment device by action of a plunger and then retracted at the end of the selected exposure time. A solenoid, electro magnet, motor, or any other conventional mechanical device can accomplish such a movement. When remote activation is not desired, even a clockwork device or other mechanical timer can be employed. The exposed SPME fibers can then be recovered and subjected to chromatography analysis. Then, by reference to the data produced via the preceding steps, the concentration of active in the air can be calculated, and the degree of the efficacy of the volatile dispensing device can be known.

By use of these methods air treatment chemical concentrations can be accurately determined, with reduced need to use human test subjects. Testing can readily be accomplished in a variety of test locations, and such testing can be performed using equipment that does not itself introduce air flow or other interfering variables into the test location.

These and still other advantages of the present invention will be apparent from the description which follows and the accompanying drawings. In them reference is made to certain preferred example embodiments. However, the claims should be looked to in order to judge the full scope of the invention, and the claims are not to be limited to just the preferred example embodiments.

### BRIEF DESCRIPTION OF THE DRAWINGS

FIG. 1 is a perspective view of equipment used for preliminary determinations of air treatment chemical concentrations useful to achieve knockdown of an insect;

FIG. 2 is a detailed perspective view of a portion of that assembly;

FIG. 3 is another detailed perspective view of the FIG. 1 assembly;

FIG. 4 is a graph depicting knockdown times versus concentration for three different insect control agents;

FIG. 5 is a frontal perspective view of another piece of test equipment, this equipment having varied collection capability;

FIG. 6 is a graph reporting on test results obtained from using the FIG. 5 equipment;

FIG. 7 is a schematic depiction of SPME response;

FIG. 8 is a perspective view of a piece of equipment used to measure effective flow velocity on SPME response;

FIG. 9 is a graph charting the results of experiments using the FIG. 8 equipment;

FIG. 10 is a schematic depiction of a test system and results obtained there from;

FIG. 11 is a schematic depiction of a coordinate system;

FIG. 12 is a flow chart representing a method of the present invention; and

FIG. 13 is a depiction of a preferred SPME collector.

### DETAILED DESCRIPTION OF THE PREFERRED EMBODIMENTS

This invention can be used to predict and measure, on a real time basis, the spatial and temporal concentration of air treatment chemicals such as insecticidal actives in ambient air. This can help determine (i) whether threshold concentrations for flying insect repellency and/or insect knockdown have been reached, and over what period; (ii) the fate of the active as it migrates in the ambient air; and/or (iii) the effect of air flow velocity and temperature.

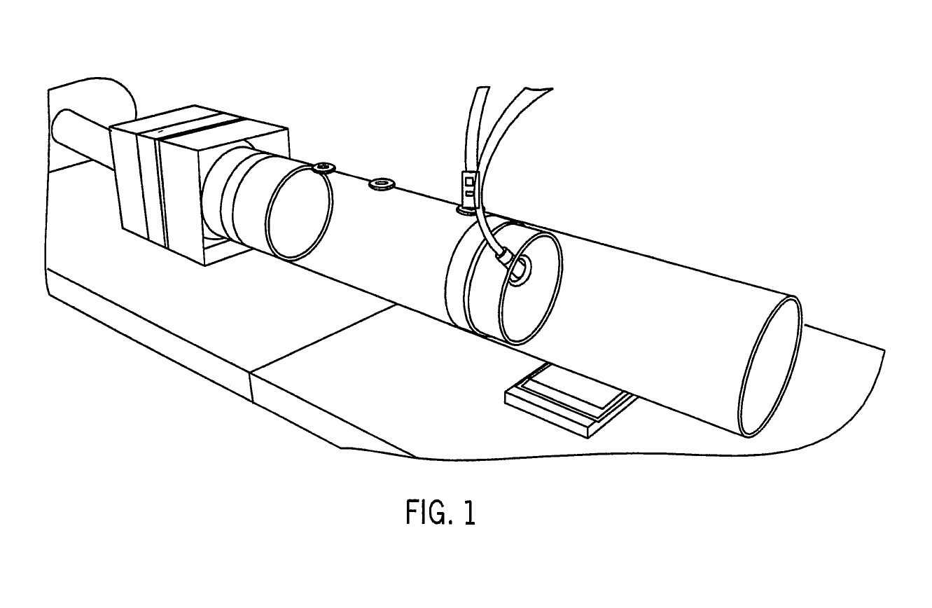

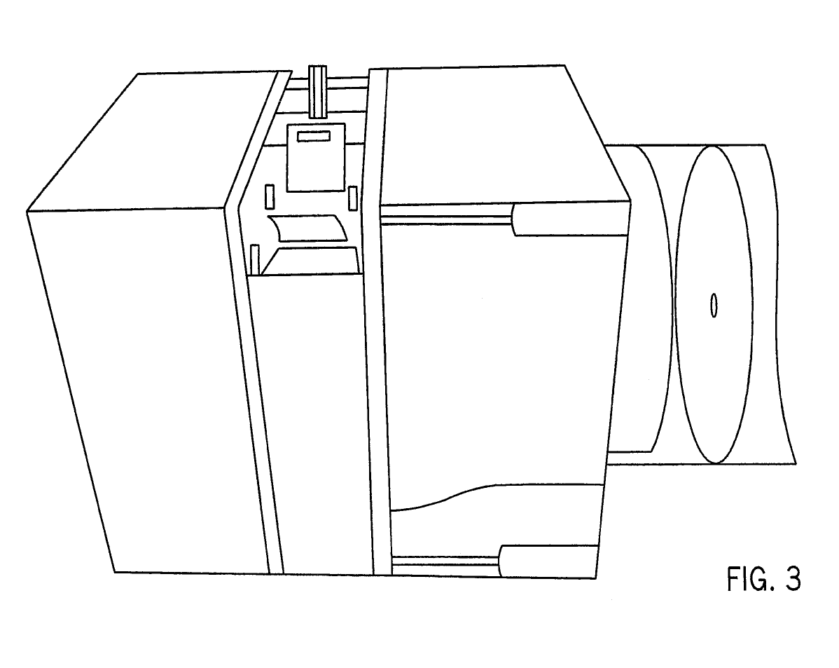

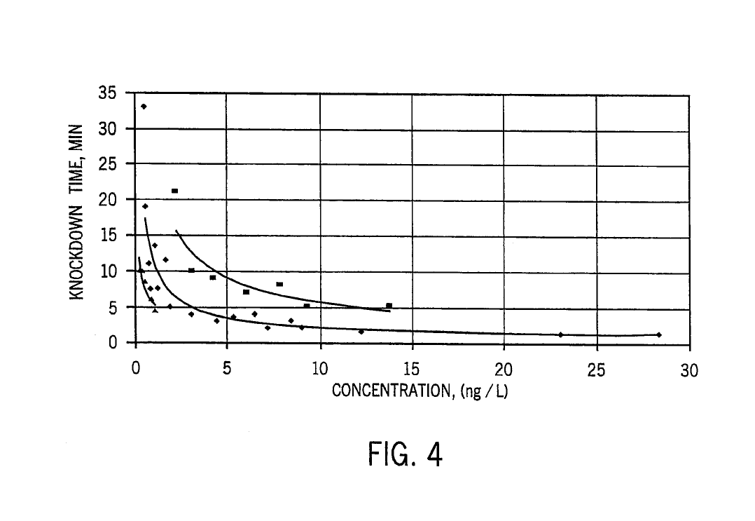

We first determine repellency and knockdown threshold concentrations. For actives that have been in use for some time, this information may already be publicly available. For a new active, this can be determined using human test subjects, or in this case of knockdown testing by using the equipment of FIGS. 1-3 as reported in our FIG. 4 graph.

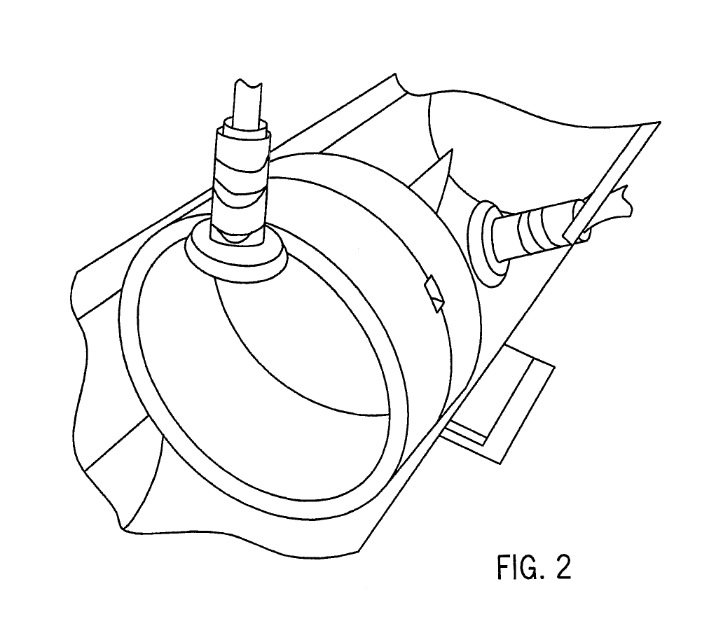

We performed knockdown testing for Culex pipiens (the common house mosquito) using an example insecticide. As shown in FIGS. 1 and 2, a tube was provided having a fan at the left end for directing air flow through the tube. The active ingredient to be tested was held on a substrate located down-wind of the fan. A ring cage (Sealrite Ltd.) for holding mosquitoes was located at the end of the tube opposite the fan. The cage had screening allowing air from the fan to freely pass through the cage, thus exposing mosquitoes in the cage to active ingredient volatilized from the substrate by the passing air. Grommets in the tube down-wind of the substrate allowed access to the active ingredient-charged air to facilitate monitoring the concentration of the active in the air at any given time.

The tube arrangement comprised four parts; a first section was inserted closest to the fan. A second, plastic section was connected to the first section so as to receive the fan's exhaust. A small ring with alligator clips for holding the substrate that emits the active was located at the up-wind end of the second section. A ring was located at the down-wind end of the second section to hold a mosquito cage in place. Holes for receiving grommets were provided for accessing the moving air within the tube arrangement by use of conventional sorbent tubes (e.g. catalog # 226-30-16 of SKC Inc.-XAD-2-OVS). A flow meter was placed in the back of the fan apparatus to monitor air flow rate. When the device was in operation, all un-used grommet holes were plugged with rubber stoppers.

After setting up this first type of equipment we took one cage containing ten mosquitoes, assembled the tube with all its parts, and ran the fan to blow air through the tube with no active ingredient on the substrate. We then recorded mosquito knockdown times. We confirmed no deaths in 30 minutes in the absence of active.

We then prepared dilutions of the active ingredient to be tested such that a 100 microliter volume of solution contained the desired level of active for deposit on the emitting substrate in each test case. The substrate chosen for this example was Whatman brand filter paper.

We used a suitable volatile solvent (e.g. acetone) for the active to prepare the dilutions. We preferred to prepare the dilutions less than sixteen hours before conducting the tests to minimize skewing the results via the use of effects of the solvent on the active. We took the loaded filter paper and secured it to the sample holder ring by using an alligator clip. We then loaded the sample holder ring with the treated filter paper at the appropriate place down-wind of the fan, and conditioned the tunnel for 30 minutes (recording temperature & humidity) at 30 L/min airflow.

We made sure to plug the holes for grommets for the sorbent tubes, using corks or rubber stoppers during this period. After 30 minutes of conditioning, we took rubber grommets and placed them in the holes that had previously been corked. We then placed the mosquito cage at the correct location downwind end of the sample holder, placed sorbent tubes at locations pre and post the mosquito cage, and started the sorbent tube pumps and a stopwatch. We then recorded mosquito knockdown every 30 seconds.

We then terminated the pumps at 30 minutes, and pulled the sorbent tubes and capped them. We placed the sorbent tubes in pre-labeled, sealable plastic bags marked with date, active, active level, test time interval, and any other pertinent information.

For cleaning between tests, we washed the tunnel parts thoroughly, using hot water and detergent and/or a washing machine, and finally rinsed them with acetone. We then place the cleaned tube parts in front of a heat source for about 45 minutes to aid in decontaminating them. We replaced grommets and plugs with new ones or decontaminated the old ones. We periodically checked the sorbent tube pump flow @ 2 L/min. We recharged pumps after eight hours of use and re-calibrate flow.

As can be seen from FIG. 4, the concentration dispensed by this particular dispensing system needed to achieve a specific knock-down effect within a specific time varies from active to active. This emphasizes the importance of developing a correlation curve particular to each active.

SPME technology conventionally only allows for collection of the active in the air at the location of the SPME fiber, and not for determination of the actual air concentration. Hence, we first establish via the sorbent tube method a standard correlation curve between air concentration (as measured by the sorbent tubes) and SPME responses in the same environment. By essentially simultaneously collecting samples at adjacent locations with both a SPME and a sorbent tube, the sorbent tube measures the air concentration at that point and lets one determine what a particular SPME reading means relative to that. Using this calibration curve it is then possible to measure using SPME only and use the readings to approximate concentration. Importantly, once the correlation curve exists, one can do further testing without any need for further sorbent tube testing or human test subject involvement.

The SPME device may have a thin fiber that consists of a silica rod (support) coated with poly dimethyl siloxane (PDMS), although the specific coating substance used varies depending on the analyte. Partition occurs through the pores of the coated material when the SPME fiber is exposed to analyte.

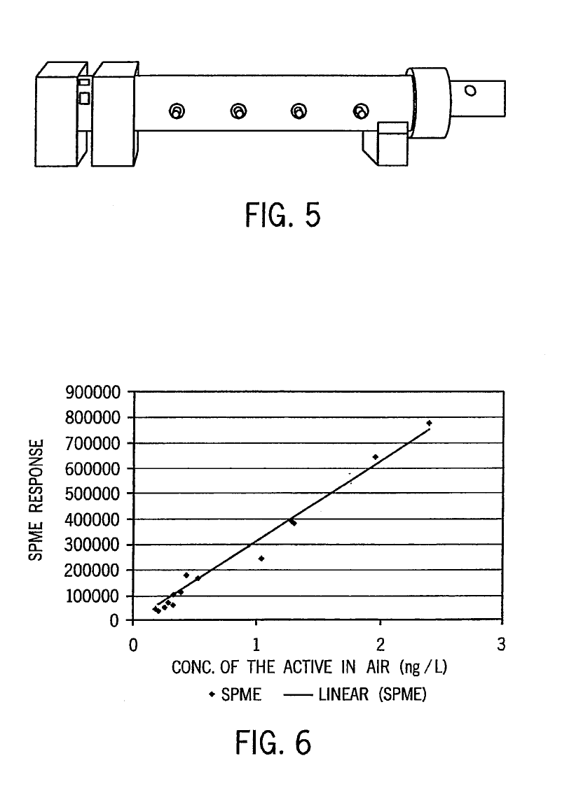

Turning now to FIG. 5, we depict a piece of equipment that can simultaneously conduct sorbent tube and SPME sampling. FIG. 5 depicts a horizontal stainless steel tube (tunnel) which has two open ends used to maintain the concentration of the active in air. One end of the tunnel was assembled with a fan which generates airflow into the tunnel. A flow meter was connected to the fan block to check the flow rate of the air.

The other end of the tunnel was narrowed by attaching a funnel shaped tube to maintain reasonably uniform concentration inside the tunnel. The tunnel had eight circular holes arranged such that there were four holes spaced equally apart and paired with four other holes on the opposite side of the tube. A metal mesh was put in between two of the positions to create some uniform mixing inside the tunnel.

As was the case in the testing described above, a stock solution of the active to be tested was prepared in acetone and diluted to desired levels. A Barex film (a plastic substrate rather than paper) was used as an example substrate to which the active was applied in a known amount, The Barex film then was placed in a sample holder that has a clip to hold the substrate.

The substrate holding a known amount of the active was put in the tunnel in front of/down-wind of the fan. As the fan blew air over the substrate, active evaporated and passed through the tunnel. SPME fibers were exposed to the moving air through the hole at specified positions, and a sorbent tube was put through a hole at the same linear position (on the opposite side) as the SPME sampler. The fibers were exposed for 2 minutes and at the same time air was pulled through the sorbent tube for 30 minutes @ 2 L/min with the help of a pump. The SPME was injected in a standard gas chromatography device to desorb the active, and the sorbent tube was extracted with 10 mL of hexane for 1 h. Measurements with successive SPME fibers and sorbent tubes were repeated over time.

We then calculated the concentration of the active in air from the sorbent tube. Concentrations (ng/ml) of the solutions extracted from the sorbent tubes were calculated by using a calibration curve obtained from standard solutions with known concentrations. These concentration values gave the total amount of the active (N) adsorbed on the sorbent.

Volume (V) of air through the sorbent (V)=30 min×2 L/min=60 L. Thus, the concentration of the active in air=N/V (ng/L)

Hence, a standard curve, like that of FIG. 6, can be developed for any given set of operating conditions of the dispensing product by running both SPME and sorbent tube sampling adjacent each other. One determines that a particular SPME reading correlates to a particular concentration in this manner. One continues this process until enough points are determined to develop the curve.

Such a curve will be of the greatest value for a given temperature (and similar temperatures) and a given air flow condition (and similar air flow conditions). To confirm reasonable optimization across a broad range of temperatures and air speeds one may want to create similar curves for other representative temperature and wind conditions.

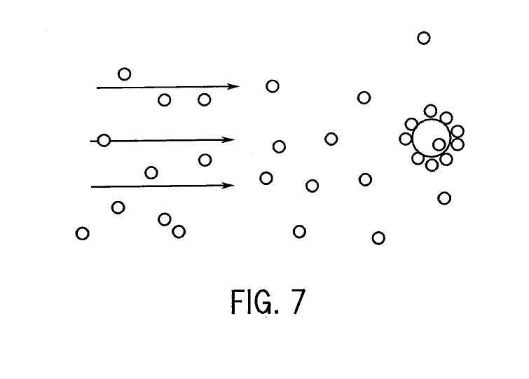

As shown in FIG. 7, as active is blown adjacent a collector fiber, the energy with which it is moved will in part determine how likely it is to be captured as it contacts the fiber in different ways. Hence, different SPME readings will occur as the wind speed increases.

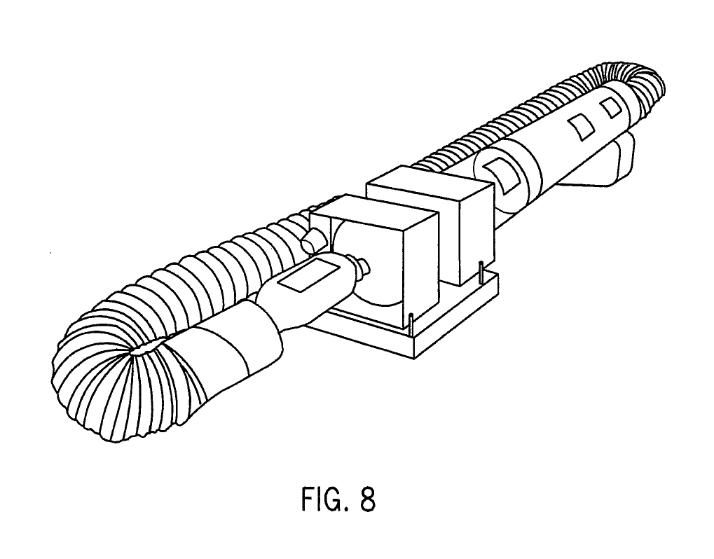

The FIG. 8 device is then used to develop standard curves that correct for this effect. The FIG. 8 tunnel is shown as connected to one end of a flexible tube and the other end of the flexible tube is connected to the flow meter to create a closed-loop system.

The Barex film was spiked with active and conditioned in the tunnel for 20 min. After conditioning, the spiked Barex film was taken out of the tunnel, leaving the air circulating within the closed-loop system with only the active that had evaporated from the Barex film to that point. This was done to keep the concentration of the active essentially constant inside the loop. Successive SPME fibers then were exposed at different, successive airflows, such as 5 L/min, 15 L/min and 30 L/min. The SPME were then analyzed by gas chromatography.

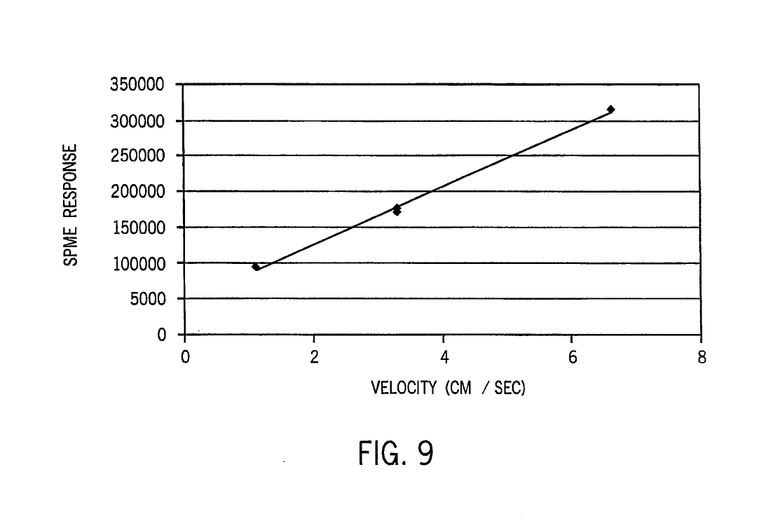

As shown in FIG. 9 the effect on SPME readings of wind velocity can be mapped and corrected for, for a particular active. Hence, one can make optimization judgments based in part on expected wind levels in the normal course of use. For example, insect biting need not be considered in a forty mile per hour environment as the insects will be inhibited from flying during those winds. On the other hand, one may well want to know whether a particular active is protective in fifteen mile per hour winds at particular distances.

Once the various curves have been developed, one no longer needs to continue sorbent tube sampling. One can then sample in various ways using SPME results, and then convert using the curves air concentration values.

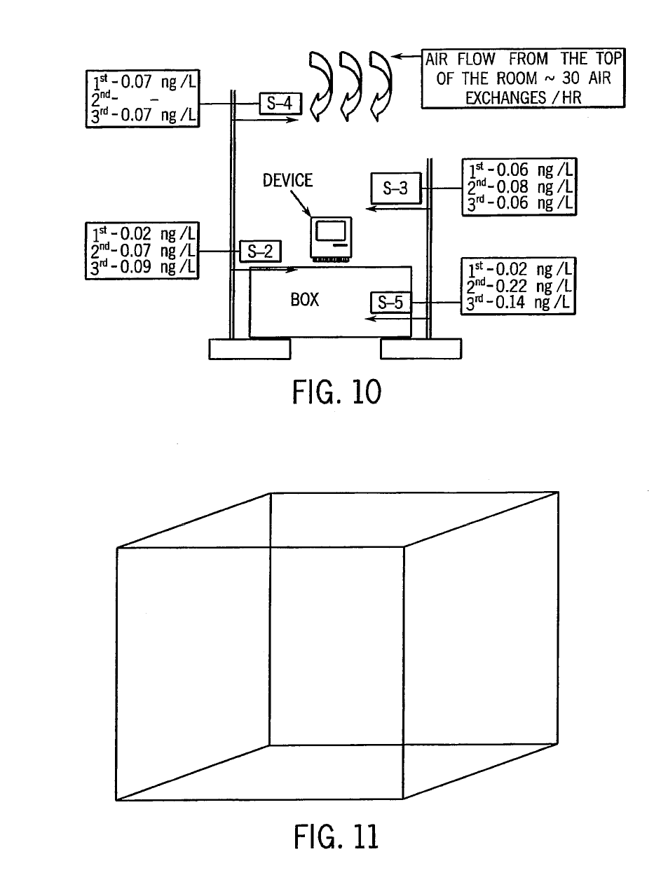

For example, as schematically shown by FIGS. 10-12, one could take samples using the SPME technique at different locations (labeled “S-2”, “S-3”, etc. in FIG. 10). We then surrounded a box covered with cloth with these samplers, with the volatile delivery product being positioned on the box.

The box was of a size such that the distribution of the SPME sampling locations corresponded to various test locations relative to a human that might have been wearing this dispenser devise. The sample collection time was 6 minutes. After being collected, the samples were analyzed by gas chromatography.

Samples were collected at approximately one hour intervals. The concentrations measured at each location are listed in the boxes of FIG. 10. Based on these results, it can be seen that concentration of the active was higher at the S-5 position (as would have been expected due to some affect of gravity and air flow from the top of the room).

To minimize any interference relating to movement of the SPME devices to obtain a temporal pattern, we provide either wired or wireless control of a solenoid to insert and remove the SPME devices at selected times. Hence, one could check air concentrations at particular times relative to initiation to see how long it takes to develop adequate protection at particular distances. Thus, someone designing mosquito control for a bedroom might well want to know how soon after the device starts the consumer can safely use the room.

The method does not always require the use of gas chromatography to measure SPME results. Other types of chromatography and measurement devices may also suffice. In any event, the methods of the present invention are best suited for materials with low vapor pressures of ˜18⁻⁵ mm Hg, but can be adapted for compounds with higher vapor pressures.

With respect to spatial arrangement where a product dispenser is centrally located in a room, there are a number of logical measurement locations in a cube like room as shown in FIG. 11. These include midpoints of each wall surface, the corners of the room box, and various co-ordinate locations within the chamber. However, test locations are not limited to square or rectangular cubes. For example, samplers can be placed at a variety of outdoor locations.

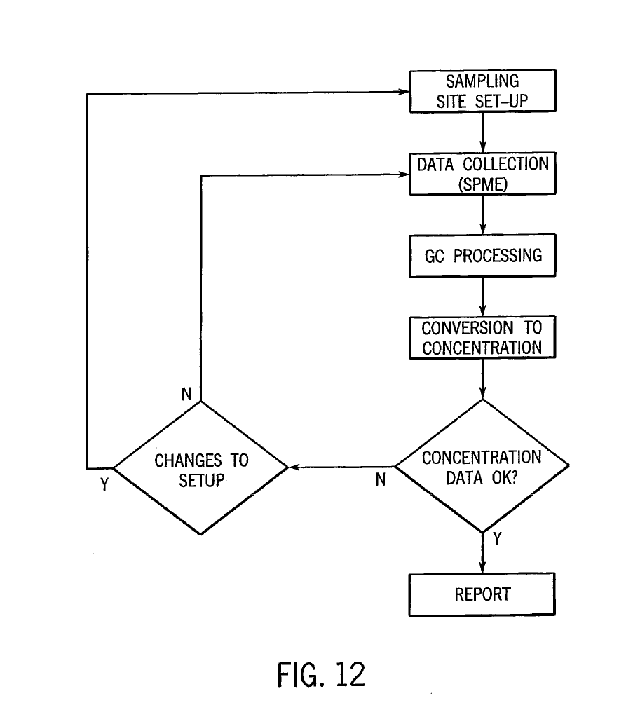

FIG. 12 shows in flowchart form how one uses our methods to optimize a dispenser. After the first set of runs one sees how the air concentrations at the desired locations compare to the optimal desired concentrations. If they are not within desired ranges, the product setup is modified in some way to try to correct for this. For example, if concentrations are too low, one might increase blower speed on the device, or the heater on the device, or increase the concentration of active on a substrate. The modified setup is then evaluated, and the method continues in this fashion until the desired concentrations are reached. For example, an insect control device which is one hundred percent natural pyrethrum on Whatman filter paper, can be optimized in this manner.

One can have a human population describe what threshold concentrations of a new fragrance can be smelled. Once that amount is determined, various dispensers for the fragrance can then be developed and optimized.

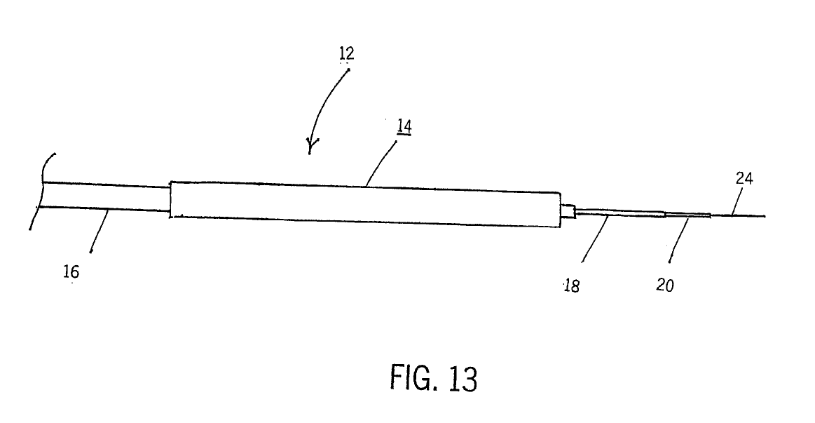

FIG. 13 depicts a preferred SPME suitable for use with the methods of the present invention. Most preferably it is the SPME fiber holder available from Sigma-Aldrich Inc. as product number 57331.

The SPME fiber holder 12 includes a barrel 14, a plunger 16, a hollow needle 18, a hollow fiber support 20 held within the needle, and a SPME fiber 24 contained within and projectable from the fiber support. The plunger 16 may be moved axially within the barrel 14 to project the fiber support 20 from the needle. With the fiber support 20 extended, further axial movement of the plunger 16 then thrusts the SPME fiber 24 itself axially outward from the fiber support, exposing a selected length of the SPME fiber.

After the SPME fiber has been exposed to volatile materials in the air for the desired time period, movement of the plunger 16 in the opposite direction retracts the SPME fiber within the fiber support 20, protecting it from further contact with any volatile materials in the air, and further retracts the fiber support within the needle 18. Any volatile material collected on the SPME fiber can then be analyzed and measured by conventional gas chromatographic means.

The plunger 16 may be moved manually, but it is preferred that it be moved by a solenoid driven, geared, or other mechanical means that, in turn, can be controlled remotely via wired or wireless connections or by a timer device. This avoids air movement or other disturbance of the test site that could result from the presence of a human operator.

Of course, other forms of SPME collectors can also be used. Thus, the invention should not be limited to just the preferred embodiments. Rather, the claims that follow should be looked to in order to judge the full scope of the invention.

### INDUSTRIAL APPLICABILITY

The present invention provides improved methods for measuring the concentration of volatile air treatment chemicals, and thus testing dispenser effectiveness, with reduced need for human test subjects.

1. A method of measuring air concentration of a volatile material in an area, comprising the steps of:
correlating sorbent tube pumped air concentration measurements of varied air concentrations of the volatile material to solid phase microextraction fiber collector responses to varied air concentrations of the volatile material;
exposing in a passive collection manner a solid phase microextraction fiber collector to air in the area; and
analyzing results of the exposing step using the results of the correlating step to estimate air concentration of the volatile material in the area from the results of the exposing step.

2. The method of claim 1, further comprising the step of delivering the volatile material into the area from a volatile dispenser prior to the exposing step.

3. The method of claim 2, wherein the exposing step comprises use of an array of solid phase microextraction fiber collectors located at selected distances and directions from the volatile dispenser, wherein at least two collectors are positioned during the exposing step at different distances from the volatile dispenser.

4. The method of claim 2, wherein the volatile material is selected from the group consisting of insect control agents and fragrances.

5. The method of claim 2, wherein the volatile dispenser is selected from the group consisting of insect control agent dispensers and fragrance dispensers.

6. The method of claim 1 wherein upon completion of the exposing step the solid phase microextraction fiber collector is automatically protected from further exposure to additional volatile material.

7. The method of claim 6, wherein the solid phase microextraction fiber collector can be automatically withdrawn into a protected holder by mechanical movement.

8. The method of claim 6, wherein the solid phase microextraction fiber collector can be automatically protected from further exposure via a remote control device.

9. The method of claim 1, wherein a solid phase micro extraction fiber collector that has collected the volatile material is subjected to chromatographic analysis.

10. The method of claim 1, wherein prior to beginning the claim 1 method one is already aware of a desired air concentration of the volatile material.

11. The method of claim 1, wherein the varied air concentrations of the volatile material to which the solid phase microextraction fiber collector response is correlated are measured by use of sorbent tube technology.

12. A method of measuring air concentration of a volatile material in an area, comprising the steps of:
correlating sorbent tube pumped air concentration measurements of varied air concentrations of the volatile material to solid phase microextraction fiber collector responses to varied air concentrations of the volatile material;
exposing a solid phase microextraction fiber collector to air in the area; and
analyzing results of the exposing step using the results of the correlating step to estimate air concentration of the volatile material in the area from the results of the exposing step;
wherein the exposing step comprises use of an array of solid phase microextraction fiber collectors located at selected distances and directions from the volatile dispenser, wherein at least two collectors are positioned during the exposing step at different heights.
